(19) United States
(12) Patent Application Publication
(10) Pub. No.: US 2013/0181536 A1
(43) Pub. Date: Jul. 18, 2013

(54) ICPT SYSTEM, COMPONENTS AND DESIGN METHOD

(71) Applicants: Kunal Bhargawa, Ponsonby (NZ); Fady Mishriki, Viaduct Harbour (NZ)

(72) Inventors: Kunal Bhargawa, Ponsonby (NZ); Fady Mishriki, Viaduct Harbour (NZ)

(73) Assignee: POWERBYPROXI LIMITED, Auckland (NZ)

(21) Appl. No.: 13/704,398

(22) PCT Filed: Jun. 15, 2011
(86) PCT No.: PCT/NZ11/00107

§ 371 Date: Apr. 1, 2013

(30) Foreign Application Priority Data
Jun. 15, 2010 (NZ) 586175

(51) Int. Cl. H01F 38/14; G06F 17/50

(52) U.S. Cl. CPC H01F 38/14; G06F 17/5068
USPC 307/104; 716/137

(57) ABSTRACT

A method for removing the effects of metallic objects in an inductively coupled power transfer system by providing a metallic casing around transmitting and/or receiving coils and compensating for their effect in the design of transmitting and/or receiving circuits. Whilst incurring some loss in performance this design reduces variability due to different metallic influences in an operating environment. Power transmitters and receivers and a system including the power transmitter and the power receiver are also disclosed.

### FIELD OF THE INVENTION

This invention relates to methods of designing power transmitters and receivers of an inductively coupled power transfer (ICPT) system and transmitters, receivers and systems produced by the methods.

### BACKGROUND OF THE INVENTION

### Contactless Power System Definition

Contactless power systems comprise a contactless power transmitter that includes a conductive path supplied with alternating current from a power supply and one or more contactless power receivers. These contactless power receivers are adjacent to, but galvanically isolated from, the conductive path. A contactless power receiver includes a pick-up coil in which a voltage is induced by the alternating magnetic field generated by the conductive path, and supplies an electric load via power conditioning. The pick-up coil is usually tuned using a tuning capacitor to increase the power transfer capacity of the system.

### Traditional Coupling Design Disadvantages

ICPT systems commonly have a conductive element called a track that is supplied with alternating current from a high frequency converter; this is called a power transmitter. One or more secondary devices (which may be referred to as power receivers) are provided adjacent to, but galvanically isolated from, the track. The power receivers have a pick-up coil in which a voltage is induced by the alternating magnetic field associated with the track, and supply a load such as batteries or electronic devices. The pick-up coil is usually tuned using a tuning capacitor to increase the power transfer capacity of the power receiver.

A problem with existing ICPT systems is in the design of the track and pick-up coil coupling when the system is used in metallic environments. ICPT systems need to have the track and pick-up coil tuned to match the system frequency to optimize the power transfer capacity of the system. This tuning can be passive (i.e. done solely by reactive component selection) or active (i.e. tuned by component selection and further compensation using reactive elements).

When a track and a pick-up coil are placed in a metallic environment their effective inductance and tuning capacitance required to maintain maximum power transfer changes. This can be compensated for if the system is actively tuned and the variation is within the active tuning bandwidth of the system. The disadvantage of actively tuned systems is that they require additional reactive elements which can be quite large depending on the tuning bandwidth and required power rating.

Passively tuned systems can be compensated for changes, however the level of compensation depends on the level of magnetic field disrupted by the mechanical surrounding, which may change during system operation.

Current state of the art ICPT systems are generally closely coupled (ie >>60%) and are affected by the introduction of metallic objects nearby. Due to this close coupling requirement these systems have very restrictive ranges and misalignment tolerances, which also requires complex mechanical mounting (see: http://www.vahleinc.com/contactless power supply.html and US 2007/0188284).

It would be desirable to provide an ICPT system, components and a method of design that reduces these problems or at least provides the public with a useful choice.

### Exemplary Embodiments

According to one exemplary embodiment there is provided a method of designing an power transmitter for an inductively coupled power transfer system including the steps of:
a. determining the inductance of a transmitting coil having an associated metallic casing; and
b. designing a transmitter circuit for the transmitting coil based on the inductance determined in step a.

According to another exemplary embodiment there is provided a method of designing an power receiver for an inductively coupled power transfer system including a power transmitter and a power receiver, the method including the steps of:
a. determining the inductance of a receiving coil having an associated metallic casing; and
b. designing a receiver circuit based on the resonant frequency of the transmitter and the determined inductance in step a.

According to a further exemplary embodiment there is provided a power transmitter for an inductively coupled power transfer system comprising:
a. a transmitting coil having an associated metallic casing; and
b. a transmitter circuit for the transmitting coil wherein the transmitter circuit is designed for operation of the transmitting coil taking into account the effect of the associated metallic casing.

According to a further exemplary embodiment there is provided a power receiver for an inductively coupled power transfer system comprising:
a. a receiving coil having an associated metallic casing; and
b. a receiving circuit for the receiving coil wherein the receiving circuit is designed for operation of the receiving coil taking into account the effect of the associated metallic casing.

There is also provided an inductively coupled power transfer system including such a power transmitter and/or receiver.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows a generalized schematic diagram of an inductively coupled power transfer system;

FIG. 2 shows a top perspective view of a transmitting coil in a metallic casing; and

FIG. 3 shows a rear perspective view of the transmitting coil shown in FIG. 2.

### DETAILED DESCRIPTION OF EMBODIMENTS OF THE INVENTION

This specification describes a design method that can be used for coupling design (tuned track and pick-up coil) of ICPT systems. This method is particularly suitable when the system is to be used in a metallic environment.

According to the invention the power transmitter and/or power receiver of an inductively coupled power transfer system are designed by determining the inductance of the associated coil when within an associated metallic casing and then designing a transmitter and/or receiver circuit based on the determined inductance of the coil(s) when within the associated casing(s).

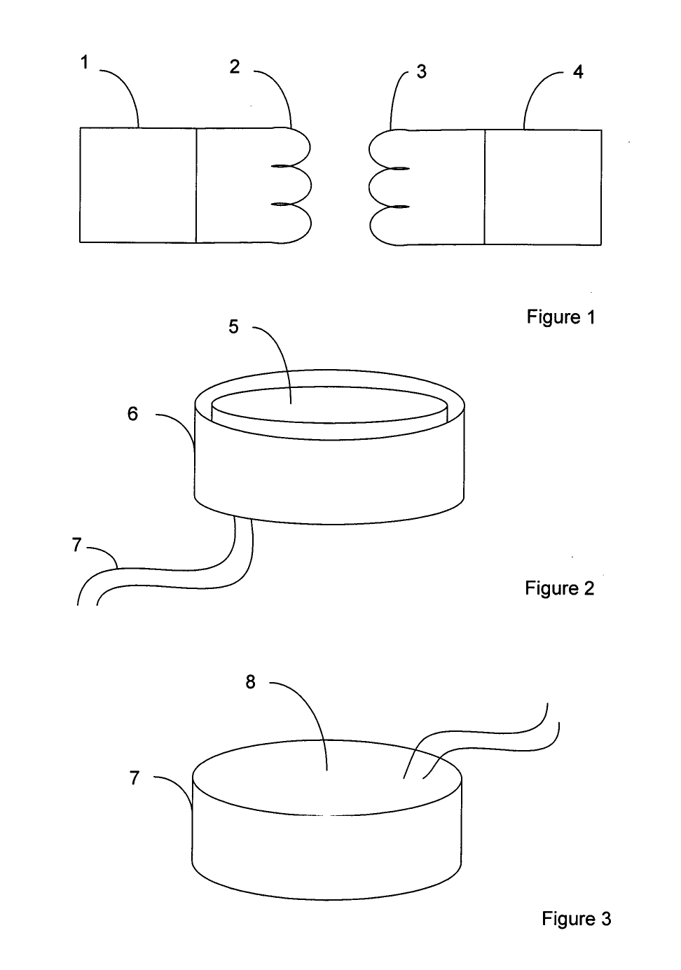

Referring to FIG. 1 there is shown a generalized schematic diagram of an inductively coupled power transfer system including a power transmitter circuit 1 driving a transmitting coil 2 and a receiving coil 3, inductively coupled to the transmitting coil 2, supplying power received to receiver circuit 4. Whilst a wide variety of transmitter and receiver circuit topologies may be employed a transmitter circuit employing a push pull stage followed by a boost converter that is parallel tuned with the transmitting coil 2 and receiver circuit employing a buck converter that is series tuned have been found to be effective.

FIGS. 2 and 3 show a transmitting coil 5 having a metallic casing 6 thereabout and terminals 7. In this case metallic casing 6 is in the form of a metal cylinder having an end plate 8, although a simple cylinder, or only partially enclosing casing may be employed. The casing may be formed of aluminium, copper or other suitable metal. The transmitting coil 5 may be a spiral wound coil which provides a good form factor or a lumped coil which provides better directionality and less interference but has a higher profile.

The transmitting coil 5 is designed to have a coil inductance value which is determined based on:
i. the optimum voltage and current capacity for the system;
ii. the coupling coefficient between transmitting and receiving coils at the required distance; and
iii. the spatial constraints of the application.

The impedance of the transmitting coil 5 within the metallic casing 6 is measured and used to calculate the capacitive compensation required to generate the correct frequency in the transmitting coil. The transmitter circuit may be designed to operate at a resonant frequency or the transmitter circuit may be designed to operate at a non-resonant frequency. The transmitter circuit may be designed so as to have a transfer function that facilitates control of power transfer.

The receiving coil may be of the same form as the transmitting coil shown in FIGS. 2 and 3. Once the inductance of the receiving coil within its associated metallic casing is determined, the receiver circuit is designed based on the resonant frequency of the power transmitter and the determined inductance of the receiving coil. The circuit may be designed to operate at resonance or it may be designed to operate over a frequency range about the resonant frequency of the power transmitter so as to control power transfer.

### Example Design Methodology

A table setting out a non-limiting exemplary design process according to one embodiment is shown below:

| Step | Details |
|---|---|
| 1 | Description |
| | Select coil design for application |
| | Requirements |
| | Power transmission metrics (power; orientation; |
| | distance) |
| | Requirements (example) |
| | Power: 240 W |
| | Orientation: Point to point |
| | Distance: 0-10 mm with a tolerance to misalignment in |
| | the other axes of 0-10 mm |
| | Key Design Parameters |
| | Coil/wire thickness; number of turns; layers |
| | Key Design Parameters (example) |
| | Ø114 mm × 3 mm (both transmitting and receiving coils) |
| | Ø3 mm wire, 19 turns and 1 layer. |
| 2 | Description |
| | Select electronics for application |
| | Requirements |
| | Power; efficiency |
| | Requirements (example) |
| | Power: 240 W |
| | Efficiency: 70%+ |
| | Key Design Parameters |
| | Rating of components and topology |
| | Key Design Parameters (example) |
| | Ø140 mm × 35 mm |
| 3 | Description |
| | Select suitable shielding casing for design |
| | Requirements |
| | Meet dimensional requirements for design |
| | Shield coil and electronics from effects of metal in |
| | surrounding environment/application |
| | Requirements (example) |
| | Have internal dimensions of Ø140 mm × 38 mm+ |
| | Hollow aluminium cylinder with one face open (to |
| | accommodate transmitting/receiving coil). |
| | The stack is: |
| | Aluminium(closed face) |
| | Electronics |
| | Coil (open face) |
| | The sides of the cylinder to run all the way to the |
| | bottom so it is adjacent to the coil as opposed to |
| | ending at the electronic stack which is the |
| | traditional method used. |
| | Key Design Parameters |
| | Coil; electronic |
| | Key Design Parameters (example) |
| | Same as steps 1 and 2 |
| 4 | Description |
| | Select power transmitter capacitor/frequency |
| | Requirements |
| | Generate correct frequency for system |
| | Requirements (example) |
| | Frequency of ~90-100 kHz required |
| | Key Design Parameters |
| | Capacitance value to compensate step 1 primary coil |
| | installed in step 3 Cₜₛ is practically selected to be a |
| | standard value (150 nF or 220 nF in this case) and |
| | minimize no. of components depending on system |
| | sensitivity |
| | Key Design Parameters (example) |
| | Lₜ = 16 uH(unshielded) |
| | Lₜₛ = 14 uH(shielded) |
| | Based on required frequency |
| | Cₜₛ(ideal) = 181 nF |
| | Requirements only allow 1 cap therefore |
| | Cₜₛ(practical) = 220 nF |
| | Fₜ (practical) = 90 kHz |
| 5 | Description |
| | Select power receiver capacitor/frequency |
| | Requirements |
| | Must match transmitter frequency (practical) for |
| | resonance when coupled |
| | Requirements (example) |
| | Frequency of 90 kHz required |
| | Key Design Parameters |
| | Capacitance value to compensate step 1 secondary coil |
| | installed in step 3 |
| | Key Design Parameters (example) |
| | Rough indication from simulation by modelling system |
| | and entering coupling co-efficient |
| | Actual value for system is determined by practical test |
| | Cᵣₛ(practical) = 267 nF |

Where:
Lₜ is the inductance of the unshielded transmitting coil
Lₜₛ is the inductance of the shielded transmitting coil
Cₜₛ is the capacitance in parallel with the transmitting coil forming a tuned circuit
Fₜ is the nominal operating frequency of the power transmitter
Lᵣₛ is the inductance of the receiving coil (which is the same as Lₜₛ in this case)
Cᵣₛ is the capacitance of the tuned circuit of the receiving circuit

The design method disclosed eliminates effects from metallic surroundings as the coupling itself is designed in a metallic casing and the design includes tuning the system for metallic environments. This approach is counter intuitive as it introduces a loss in performance through the introduction of the metallic casing. However, whilst incurring some loss in performance this design eliminates the variability due to different metallic influences in an operating environment.

This method can also be applied in conjunction with ferrite material when implementing parallel IPT systems with multiple coupling coils which need to be decoupled from adjacent coils and coupled with the intended pick-up coils.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1. A method of designing a power transmitter for an inductively coupled power transfer system including the steps of:
a. determining the inductance of a transmitting coil having an associated metallic casing; and
b. designing a transmitter circuit for the transmitting coil based on the inductance determined in step a.

2. A method as claimed in claim 1 wherein the power transmitter is designed to operate at a resonant frequency.

3. A method as claimed in claim 1 wherein the power transmitter is designed to operate at a frequency other than a resonant frequency.

4. A method as claimed in claim 3 wherein the transfer function of the power transmitter is selected to facilitate control of power transfer of the power transmitter.

5. A method as claimed in claim 1 wherein the transmitting coil is generally cylindrical and the metallic casing includes a ring about the periphery of the transmitting coil.

6. A method as claimed in claim 5 wherein the metallic casing includes a metallic end plate at one end of the transmitting coil.

7. A method as claimed in claim 1 wherein the transmitting coil is a spiral wound coil.

8. A method as claimed in claim 1 wherein the transmitting coil is a lumped coil.

9. A method as claimed in claim 1 wherein the transmitter circuit includes a boost converter.

10. A method of designing a power receiver for an inductively coupled power transfer system including a power transmitter and a power receiver, the method including the steps of:
a. determining the inductance of a receiving coil having an associated metallic casing that partially encloses the receiving coil; and
b. designing a receiver circuit based on the resonant frequency of the transmitter and the determined inductance in step a.

11. A method as claimed in claim 10 wherein the power transmitter is designed in accordance with the method of claim 1.

12. A method as claimed in claim 10 wherein the power receiver is designed to operate at the resonant frequency of the power transmitter.

13. A method as claimed in claim 10 wherein the power receiver is designed to operate over a frequency range about the resonant frequency of the power transmitter so as to control power transfer.

14. A method as claimed in claim 10 wherein the receiving coil is generally cylindrical and the metallic casing includes a ring about the periphery of the receiving coil.

15. A method as claimed in claim 14 wherein the metallic casing includes a metallic end plate at one end of the receiving coil.

16. A method as claimed in claim 10 wherein the receiving coil is a spiral wound coil.

17. A method as claimed in claim 10 wherein the receiving coil is a lumped coil.

18. A method as claimed in claim 10 wherein the receiving circuit includes a buck converter.

19. A power transmitter for an inductively coupled power transfer system comprising:
a. a transmitting coil having an associated metallic casing; and
b. a transmitter circuit for the transmitting coil wherein the transmitter circuit is designed for operation of the transmitting coil taking into account the effect of the associated metallic casing.

20. A power transmitter as claimed in claim 19 wherein the transmitter circuit is designed to operate at a resonant frequency when driving the transmitting coil.

21. A power transmitter as claimed in claim 19 wherein the transmitter circuit is designed to operate at other than a resonant frequency when driving the transmitting coil.

22. A power transmitter as claimed in claim 21 wherein the transfer function of the power transmitter is selected to facilitate control of power transfer of the power transmitter.

23. A power transmitter as claimed in claim 19 wherein the transmitting coil is generally cylindrical and the metallic casing includes a ring about the periphery of the transmitting coil.

24. A power transmitter as claimed in claim 23 wherein the metallic casing includes a metallic end plate at one end of the transmitting coil.

25. A power transmitter as claimed in claim 19 wherein the transmitting coil is a spirally wound coil.

26. A power transmitter as claimed in claim 19 wherein the transmitting coil is a lumped coil.

27. A power receiver for an inductively coupled power transfer system comprising:
a. a receiving coil having an associated metallic casing that partially encloses the receiving coil; and
b. a receiving circuit for the receiving coil wherein the receiving circuit is designed for operation of the receiving coil taking into account the effect of the associated metallic casing.

28. A power receiver as claimed in claim 27 wherein the power transmitter is designed in accordance with the method of any one of claims 10 to 18.

29. A power receiver as claimed in claim 27 wherein the power receiver is designed to operate at the resonant frequency of the power transmitter.

30. A power receiver as claimed in claim 27 wherein the operating frequency of the power receiver can be adjusted over a frequency range about the resonant frequency of the power transmitter so as to control power transfer.

31. A power receiver as claimed in claim 27 wherein the receiving coil is generally cylindrical and the metallic casing includes a ring about the periphery of the receiving coil.

32. A power receiver as claimed in claim 31 wherein the metallic casing includes a metallic end plate at one end of the receiving coil.

33. A power receiver as claimed in claim 27 wherein the receiving coil is a spiral wound coil.

34. A power receiver as claimed in claim 27 wherein the receiving coil is a lumped coil.

35. A power receiver as claimed in claim 27 wherein the receiving circuit includes a buck converter.

36. A system including a power transmitter as claimed in claim 19 and a power receiver.

37.-38. (canceled)
